(19) United States
(12) Patent Application Publication
(10) Pub. No.: US 2016/0370179 A1
(43) Pub. Date: Dec. 22, 2016

(54) SYSTEM AND METHOD FOR CALIBRATION AND ACCURACY OF DEVICE SENSORS AND RELATED EXPERIENCES

(71) Applicant: WASAKA LLC, New York, NY (US)

(72) Inventors: Biagio William Goetzke, New York, NY (US); Gregory Aaron Kohanim, New York, NY (US)

(21) Appl. No.: 14/743,965

(22) Filed: Jun. 18, 2015

(51) Int. Cl. G01C 17/38

(52) U.S. Cl. CPC G01C 17/38

(57) ABSTRACT

The system of the present disclosure has an algorithm that can correct sensor data for one or more devices, such as mobile devices. The system comprises one or more of the devices, a cloud or server, and algorithms. The algorithm can be resident on the devices, the cloud, or both. The algorithm receives data from one or more sensors on each device, and supplies a data set back to the device, along with corrected data that adjusts any error in the sensors on the device. In this way, the system and algorithm of the present disclosure can account for and correct erroneous sensor data on a user's device, thus enhancing the user's experience with the device. The algorithm may also supply an overlay or data set to the device, and can allow the user to manipulate it.

### BACKGROUND OF THE DISCLOSURE

1. Field of the Disclosure

The present disclosure relates generally to methods for improving the accuracy of sensor data in electronic devices through various embedded, application and cloud-based solutions and algorithms. In particular, the present disclosure related to solutions and algorithms that enable better and more reliable representation of perspective, location, direction, overlaying of content and spatial relationships in three dimensions.

2. Description of the Related Art

The accuracy of individual sensors and associated data in a device is prone to inaccuracies. So much so, in fact, that enabling valuable experiences (e.g., image or data overlays on the device) based on this sensor data can frequently be difficult if not impossible. For example, the compass or magnetometer in many devices is very susceptible to drift and/or magnetic interference, as illustrated in FIG. 1.

FIG. 1 provides an illustration based on a real-world example, where multiple identical devices with the same hardware sensors are all reporting a different heading when pointed in exactly the same direction and from the same location. While this example only illustrates the output of a single sensor, in this case the compass or magnetometer, the same phenomena (erroneous sensor readings) applies to the output of other hardware sensors as well. Additional sensors exhibiting this error would include, but are not limited to GPS, EXIF or image data, accelerometers, other hardware sensors, or related data.

As a result, for location based applications that rely on directional accuracy, navigation or other heading-dependent solutions are prone to extreme inaccuracy. This may, for example, take the user off course in a map application, or providing incorrect information about their surroundings (e.g., the location of a landmark). While it is possible for some of the sensors in mobile devices to be calibrated, every sensor is somewhat different and therefore, it becomes the responsibility of the user, the application, or the developer to implement workarounds that account for and resolve these inaccuracies for any particular device in order to enable an accurate output or augmented output through an offset calculation.

The present disclosure resolves these inefficiencies.

### SUMMARY OF THE DISCLOSURE

The present disclosure provides a system and algorithm that can correct sensor data for one or more devices, such as mobile devices. The system comprises one or more of the devices, a cloud or server, and algorithms. The algorithm can be resident on the devices, the cloud, or both. The algorithm receives data from one or more sensors on each device, and supplies a data set back to the device, along with corrected data that adjusts any error in the sensors on the device. In this way, the system and algorithm of the present disclosure can account for and correct erroneous sensor data on a user's device, thus enhancing the user's experience with the device.

Thus, in one embodiment, the present disclosure provides a system for correcting sensor data of a device, comprising a device comprising a sensor, a computing cloud, wherein the device is in communication with the computing cloud, and an algorithm resident on the device, the computing cloud, or both of the device and the computing cloud. The algorithm acquires sensor data from the sensor, transmits a data set back to the device, calculates an offset error in the sensor data based on the data set, and transmits corrected offset data back to the device.

### DESCRIPTION OF THE FIGURES

FIG. 1 shows a plurality of devices according to the prior art.

FIG. 2 is a schematic drawing of a system of the present disclosure.

FIGS. 3a and 3b are schematic drawings of a user employing a first embodiment of the present disclosure.

FIGS. 4a and 4b are schematic drawings of a user employing a second embodiment of the present disclosure.

FIGS. 5a and 5b are schematic drawings of a user employing a third embodiment of the present disclosure.

FIG. 6 is a schematic drawing of a user employing a fourth embodiment of the present disclosure.

FIGS. 7a and 7b are schematic drawings of a user employing a fifth embodiment of the present disclosure.

FIG. 8 is a schematic drawing of a user employing a sixth embodiment of the present disclosure.

FIG. 9 is a schematic drawing of a user employing a seventh embodiment of the present disclosure.

FIGS. 10a and 10b are schematic drawings of the algorithm of the present disclosure applying corrected data to a device.

FIGS. 10a and 10b are schematic drawings of the algorithm of the present disclosure applying corrected offset data to a device.

FIG. 11 is a schematic drawing of the algorithm of the present disclosure applying corrected offset data to multiple devices.

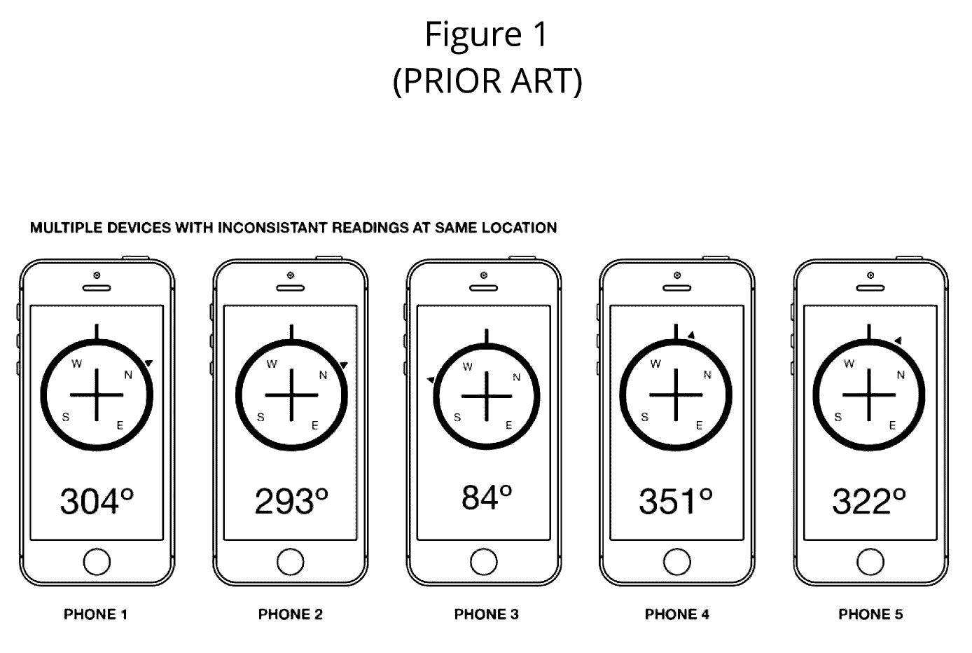

### DETAILED DESCRIPTION OF THE DISCLOSURE

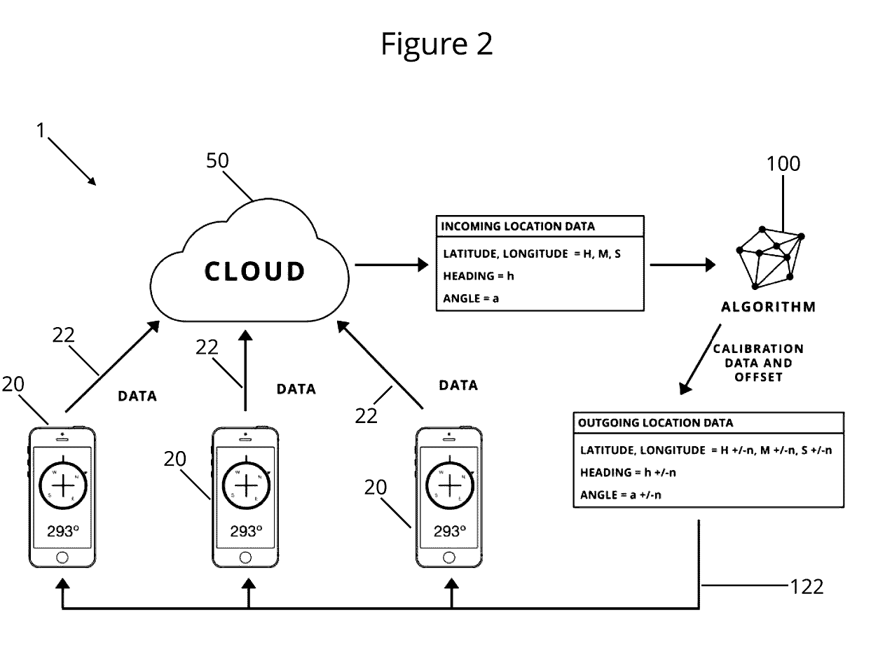

Referring to the Figures, and in particular FIG. 2, a system 1 of the present disclosure is shown. System 1 includes one or more devices 20, each of which are connected to cloud 50. Each device 20 acquires data 22 through one or more sensors (not shown) in each device 20. Devices 20 communicate this data 22 to cloud 50. Algorithm 100 of the present disclosure can reside on devices 20, on cloud 50, or both. Algorithm 100 receives data 22 from each of devices 20, and feeds corrected data 122 back to each of devices 120. Corrected data 122 can include offsets and other parameters that correct sensor errors in devices 20. Stated another way, once data 22 is passed to cloud 50 (or another internet connected service) provided by this disclosure, algorithm 100 would analyze and incorporate all device data in aggregate and return more accurate or corrected offset data 122 based on the community of devices 20 within system 1.

Thus, system 1 and algorithm 100 of the present disclosure improve the accuracy of a network of community devices 20 and their associated sensors. The present disclosure provides for individual calibration and offset solutions for each of devices 20. Additionally, algorithm 100 will ingest individual data 22 from each device 20 and associated sensor(s). With algorithm 100, this disclosure provides better sensor accuracy across all devices 20 in system 1 that are connected to cloud 50. While all of the calibration and sensor offset parameters (i.e., corrected data 122) can be stored directly on each device 20 and made available to an application or operating system, one additional advantage of this disclosure is that it enables the individual device 20, sensor and corrected data 122 to be shared and stored centrally, processed and shared across all devices 20 and related sensors.

The sensor data 22 which is provided by each of devices 20 could include, but is not limited to, the location of device 20, its heading, the track of device 20 (i.e., the line between points in its motion), the device type, the operating system of device 20, its perspective, image data (e.g. exchangeable image file format, EXIF), information relating to a user of device 20, the operating system of device 20, user or application-initiated offset, targets, a category of device 20 (e.g., “wearable” “all Android users”, “people in Madrid”, “people looking for restaurants”), user preferences, or any combinations thereof. Data 22 can be explicit, i.e. user generated or submitted. Data 22 as analyzed by algorithm 100 can also be implicit, i.e. inferred or determined indirectly by algorithm 100 from the explicit data 22 supplied by a user. Corrected data 122 as provided by algorithm 100 can be calculated based on explicit or implicit data 22.

For ease of description, device 20 in the present disclosure is described and depicted as a mobile phone. The present disclosure contemplates that device 20 may be other devices such as mobile smart phones, tablets, laptops, or any device that requires or uses accuracy in sensor technologies to provide an accurate representation of position, perspective location heading, time of day, or other parameters. Devices 20 must also have the ability to connect to cloud 50 and algorithm 100, as described herein. The connectivity between device 20 and cloud 50 does not have to be always on or continuous. The connectivity is only necessary at the time of data exchange between device 20, cloud 50, and algorithm 100. Calculations performed by algorithm 100 locally on device 20 can be conducted without a connection to cloud 50.

Algorithm 100 of the present disclosure can reside on local device 20, within cloud 50, or both. In the latter embodiment, a first portion of algorithm 100 resides on local device 20, and a second portion resides in cloud 50. The division of computing between device 20 and cloud 50 may depend on the relative amount of processing power available on device 20 and in cloud 50. For example, in one embodiment, many of the calculations are conducted on device 20, based on acquired sensor and other local data as described above and herein. The remaining functions of algorithm 100 can be conducted on cloud 50. The second portion of algorithm 100 that resides on cloud 50 can be responsible for acquiring the information in data set 30′, and collating and analyzing all of the data 22 received from devices 20. As the relative processing power of devices 20 and cloud based services changes, the present disclosure contemplates that the division of computing may change. As devices 20 become increasingly powerful, more calculations can be performed locally if desired.

As used in the present disclosure, the term “device” may refer to a mobile phone, a tablet, or any other digital device capable of acquiring an image and input/output communication. A “device” in the present disclosure may require input and or interaction from a user, and would also be known as a “user device”. A “device” in the present disclosure may also be a fully autonomous device capable of interaction with algorithm 100 and cloud 50 as described herein. In the Figures, for convenience, device 20 is shown as a mobile phone. As previously discussed, algorithm 100 may reside on device 20, be located remotely on a server or cloud 50, with which device 20 would communicate, or both. Furthermore, the term “cloud” is used for ease of description. A “cloud” as used in the present disclosure can refer to a server or network-attached service where algorithm 100 can reside.

Device(s) 20, cloud 50, and/or algorithm 100 may also act collectively as an agent or software agent. In this mode, the agent would act autonomously for certain desired tasks, and without any required command from a user. Stated another way, system 1 can have a software agent that acts on behalf of user 10, or a device 20 to generate the most contextually aware query to retrieve a result, experience, or data set 30′.

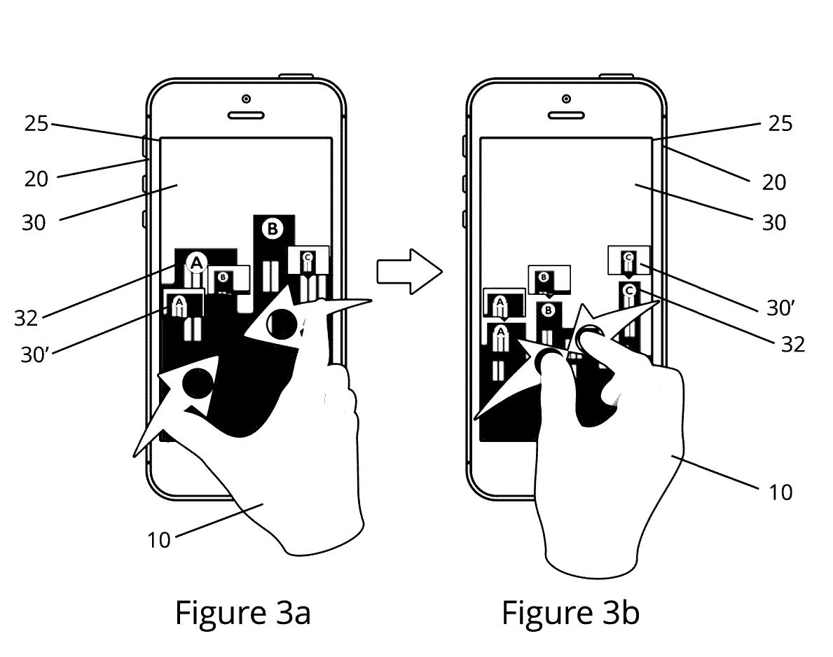

Referring to FIG. 3, one embodiment of this disclosure is shown. In FIG. 3, a user 10 of device 20 would be presented with an overlaid augmented reality experience or data set 30′ on top of a real time image 30 provided on display 20. Device 20 would acquire image 30 with a camera sensor (not shown). Device 20 may also show other sensor data on display 25, which could include, but is not limited to, a map, a horizon, one or more points of interest, or any combinations thereof.

In the Example of FIG. 3, user 10 would point device 20 in a given direction and the camera (not shown) on device 20 would output a continuously updating real time image 30 on display 25. On top of this real time image 30, a data set 30′ relating to a feature or object 32 within image 30 can be overlaid. To obtain data set 30′, algorithm 100 can receive and analyze data 25, and acquire additional relevant information, such as a map, points of interest, or other information associated therewith. This information can be acquired from any databases of information such as sources of structured or unstructured data that contain location or other information (e.g., Google® Maps, Wikipedia®, weather services, or community or user-generated content and data, either explicit or implicit), or other related services.

Data set 30′ can be one or more thumbnail images, one or more pins indicating points of interest, a full, “ghost” image that is overlaid onto image 30, or other content. Data set 30′ may also include, for example, what is depicted in image 30, relevant or interesting facts about objects therein, when an object in image 30 was completed (e.g. date of creation of a work of art, date of construction of a building), how to interact with objects in image 30 (e.g. visiting hours or location for a landmark), the name of the artist or other persons associated with an object in image 30, who in the user's network has engaged with any objects in image 30, similar objects, or other information. If the overlaid data set 30′ doesn't accurately line up with the corresponding feature or object 32 in real time image 30, the user would have the ability to shift and align the overlaid content with the real time image through the following methods.

In FIGS. 3a and 3b, user 10 can manually shift data set 30′ on image 30 using a tap, pinch, and/or zoom gesture as shown. If data set 30′ is inaccurately represented or positioned in image 30 with respect to object 32, the user would use finger-based gestures on a touch screen to zoom data set 30′ in and out until it lines up with object 32. Algorithm 100 tracks and calculates the amount of offset applied by user 10, and can use it to modify, for example, a GPS location provided by a sensor in device 20, or a heading calculated by device 20. The offset performed locally on a device 20 by user 10 may also be sent to cloud 50, and used for all devices 20 in system 1 (via corrected data 122). The present disclosure contemplates that other methods aside from pinch and zoom may be used to move and adjust data set 30′ within image 30.

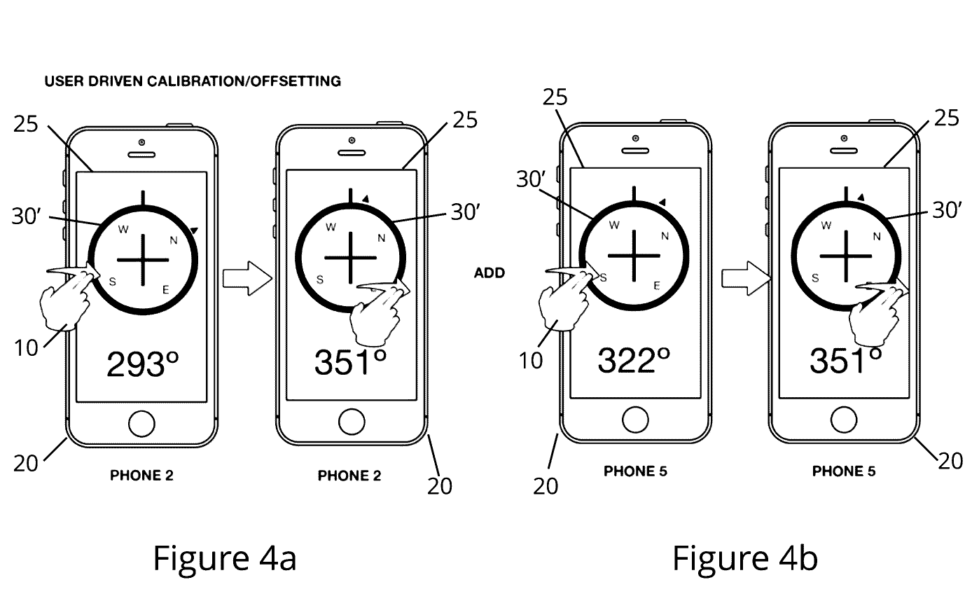

As shown in FIGS. 4a-4b, algorithm 100 provides user 10 with a data set 30′ that resembles a wheel. User 10 can rotate the wheel in data set 30′ until it matches a desired heading, which will ensure that the sensors within device 20 are properly calibrated.

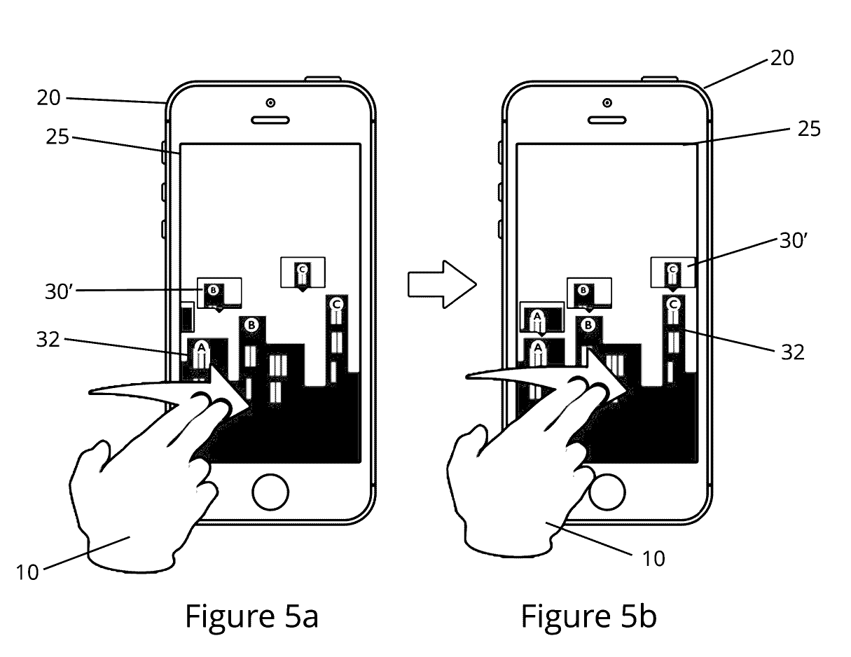

As shown in FIGS. 5a and 5b, algorithm 100 may also provide user 10 with the ability to adjust the location of data set 30′ using a swipe or physical pan gesture. Similarly to the embodiments shown in FIGS. 3a-4b, if the overlaid content 30′ is inaccurately represented due to an inaccurate representation of heading or angle to a known object 32, the user can use finger-based gestures on a touch screen to pan and shift data set 30′ direction until data set 30′ lines up with the corresponding object 32 in image 30. In the embodiment of FIGS. 5a and 5b, user 10 “grabs” data set 30′ by touching it on image 30, and moves it to a desired location. As in other embodiments, the amount of offset applied is calculated, stored, and analyzed by algorithm 100, and reported to other devices 20 within system 1 as needed. One or more of the pinch and zoom adjustment of FIGS. 3a and 3b, the wheel adjustment of FIGS. 4a and 4b, and the grab and swipe method of FIGS. 5a and 5b can be used in conjunction with one another.

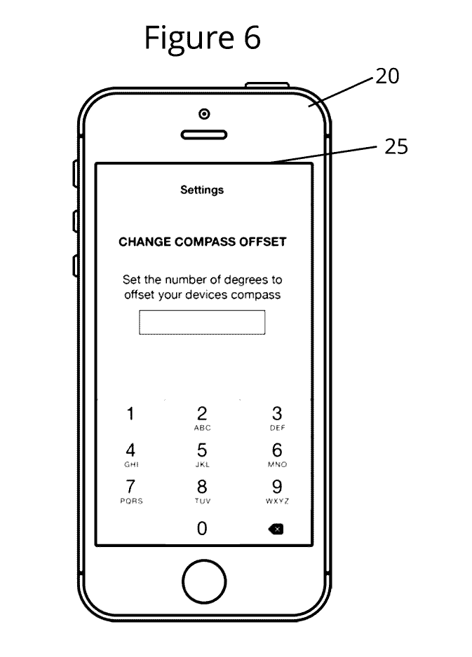

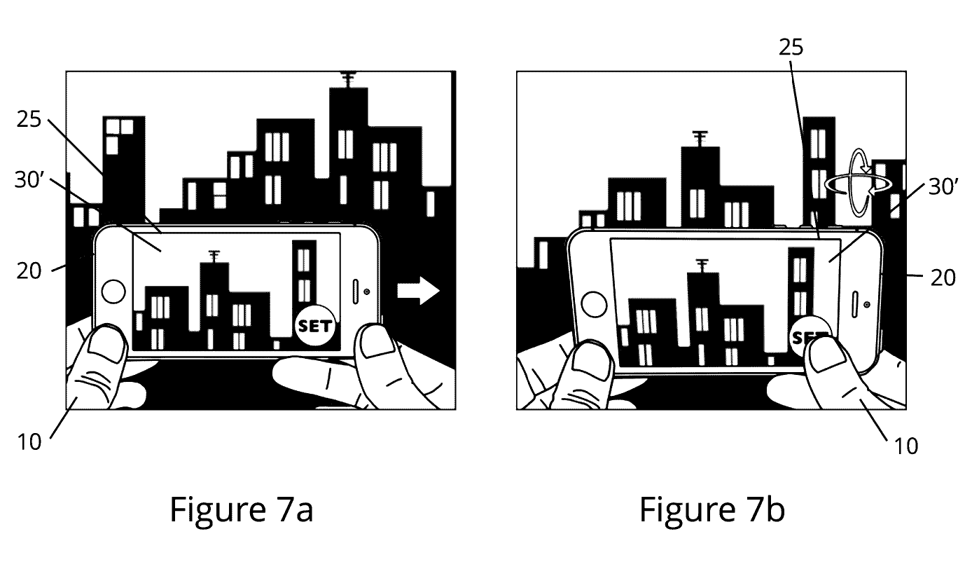

The present disclosure also contemplates that algorithm 100 of the present disclosure could give user 10 the ability to calibrate sensor-offset data for one or more sensors directly. For example, in the case of a magnetometer/compass, the user would have the ability to directly calibrate the sensors offset data using one or more methods. As shown in FIG. 6, algorithm 100 could present the user with a prompt on display 25 that allows the user to manually enter a compass offset. The ability to directly enter an offset with manual gestures by manipulating a wheel, scroll wheel or slider control is shown in FIGS. 4a and 4b and described above. As shown in FIGS. 7a and 7b, algorithm 100 can also allow user 10 to set an offset by physically repositioning the device and its corresponding sensor while a static image is “frozen” on the device's display 25. Here, algorithm 100 provides a data set 30′ in the form of a static image on display 25. The user 10 can manipulate device 20 (e.g., flip, tilt, pitch, roll, yaw, or rotate it) until the actual real time image 30 matches what is shown in data set (i.e., a frozen image) 30′.

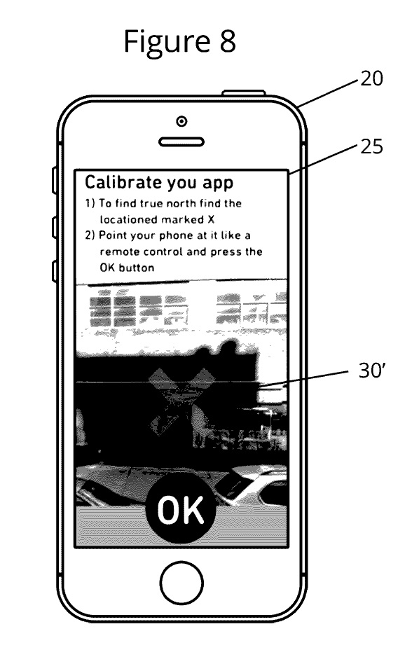

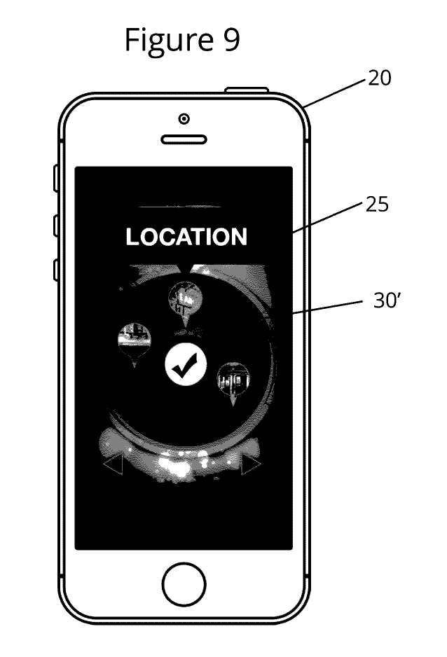

In another embodiment, shown in FIG. 8, algorithm 100 can provide a data set 30′ in the image of a mark or “X”, as shown. Algorithm 100 can identify an object of known location or bearing, in this case true north. Algorithm 100 can prompt user 10 to align their device 20 with this known location or bearing, and calculate the offset needed to achieve this alignment. Similarly, in FIG. 9, algorithm 100 can provide data set 30′ in the form of a pin or thumbnail image of a known object 32 in the area where user 10 is located. Algorithm 100 can prompt user 100 to align the content in data set 30′ with the real time counterpart in image 30. For example, in the embodiment of FIG. 9, algorithm 100 can provide data set 30′ in the form of a thumbnail image of a nearby building, and ask user to align that thumbnail image with the real time image of that same building. Algorithm 100 would then calculate the sensor offset data needed to achieve this alignment.

In any of the embodiments shown in FIGS. 3a-9, algorithm 100 can calculate the offset associated with mating data sets 30′ to their corresponding images 30, and the objects 32 therein. As discussed in greater detail below, these offsets can be calculated locally on devices 20, or within cloud 50. Algorithm 100 then stores and analyzes the offset data. Algorithm 100 can then send and apply corrected data 122 to other devices 20 within system 1 as needed.

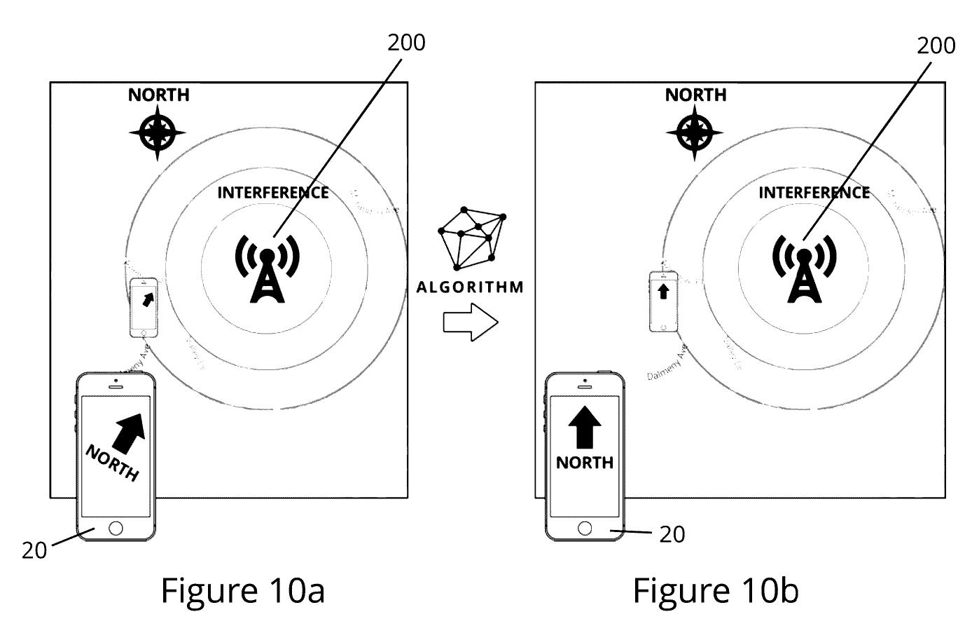

FIGS. 10a and 10b show a schematic representation of how algorithm 100 can identify and account for sources of interference within an area where user 10 has device 20. In FIG. 10a, a source of interference 200 disrupts the sensors in device 20, and causes incorrect readings. For example, magnetic interference, as shown, may disrupt the compass readings within device 20. As described in the several embodiment above, algorithm 100 can calculate needed offset correction data 122, and apply them to device 20, so that the compass reading is correct, even when subjected to the interference source 200 (FIG. 10b).

As one example, when a source of interference 200 is magnetic, algorithm 100 calculates corrected data 122 based on the feedback (i.e., data 22) it received from one or more devices 20. Through data 22, algorithm 100 applies detection and triangulation methods to identify and store the location and strength of stationary or semi-stationary magnetic fields that can interfere with the accuracy of an embedded sensor in device 20, and then apply the required offset, by location. By capturing the three dimensional data 22 in real time from all three axes of a magnetometer on device 20, algorithm 100 would identify any interference and continually update magnetometer offset calibration to filter out any interference of the sensor due to external magnetic forces. In this case, algorithm 100 would calculate an average offset that combines the strength and direction of multiple magnetic sources to determine the averaged direction of magnetic north.

While the above solutions are valuable to improve the accuracy of sensor data output that can be leveraged by individual devices 20, sensors or users 10, this disclosure also provides the ability for individual calibration offset data to be passed over a network at any configurable interval to a centralized portion of algorithm 100 which would analyze and compute the aggregation of offset data for all connected devices 20 in system 1. As previously discussed, corrected data 122 could then be sent back to connected devices 20 to improve the perceived accuracy of sensor-output data for all devices 20 and the sensors associated therewith. Algorithm 100 can employ one or more of the following methods to provide corrected data 122:
Multiple devices 20 contain sensor data. Through an application or other method on device 20, which could be an embedded function of an operating system, the devices could pass one or more of the following data 22 to cloud 50 or service-based algorithm 100:
   Device-specific data (type, model, operating system, version, mac address, unique and/or proprietary identifier)
   Location data (GPS coordinates, elevation, GPS accuracy, track)
   Positional data (angle, perspective data, heading)
   User data (login, usage, history)

The above-listed data examples are not limiting, but merely illustrative. Algorithm 100 uses this data 22 in multiple ways, including but not limited to the following:

1. For identifying pattern matches between sensor inaccuracies specific to common device models. For example, algorithm 100 could identify a pattern where all devices 20 of one certain model and revision number for a given device have a magnetometer inaccuracy of between +15 and +25 degrees whereas all devices of another model and revision number for a given device have a magnetometer inaccuracy of between −25 and −35 degrees. This data would be calculated at the individual device 20 level, as described in one of the embodiments above. For example, algorithm 100 can calculate the raw data 22 output of the sensor, and offset by the calculated data (e.g., magnetic heading) provided by one of the user/device-calculated offset values provided by one or more of the solutions documented above. Once these patterns are identified by algorithm 100, it would calculate the average offset for all matching devices 20, which would be weighted depending on prominence, reliability of the data (based on user history and usage) and frequency to determine confidence for the offset data provided by any given device and then aggregate the results for all networked devices. As one example of this embodiment:
a. Algorithm 100 identifies that 1,000 of 10,000 devices in system 1 are iPhone® 4S, based on data 22 provided by devices 20.
b. Of these 1,000 iPhone® devices 20, 800 of them have provided offset data 22 for one or more of their sensors (in this example, we will use magnetometer offset data). Algorithm 100 establishes a confidence as to whether the 200 devices that don't report offset data are either natively accurate or simply that no offset data 22 has been calibrated or passed to the service, based on history, usage and other user data.
c. Of these 800 devices 20, 700 of them provide an offset that is a positive offset, whereas 100 of them provide a negative offset.
d. For the reporting devices 20 in each set, algorithm 100 would further refine a calculated average for accuracy based on location. It identifies patterns where groups of devices that also share other similar data—in this case, GPS location.
e. Algorithm 100 determines that of the 800 devices 20 that provide sensor offset data, that a plurality of devices—in this case 600, fall within 10 macro geographic areas. Algorithm 100 further refines that within each of these 10 macro geographic areas that it will group the devices that are members of these groups into 50 micro areas per group.
f. As a result of the above, algorithm 100 will then refine the sample set for each grouping to dismiss anomalous data, but retain a history of this anomalous data for future calculation. For example, within one macro geographic area, we might find that for each of the 50 micro areas, that within each that there is majority-consistency of the reporting devices 20 within the specific micro areas. For example, within a given macro area, for the same device type, a majority, say 90% of reporting devices all provide a calibration offset of between +5 and +15 degrees. In looking at the identified micro areas, algorithm 100 further calculates that that a majority of reporting devices (80%) also provides a high consistency in reported offset data 22 with similar values as above. For the remaining 20% in a micro area, the algorithm further finds that of this 20%, 80% of devices are providing similar offset results or data 22 that deviate from the median for that macro and micro area. Using this data 22, algorithm 100 is able to identify location-specific offset corrected data 122 that can be applied and also assume that the offset is a result of highly-localized magnetic interference. For the remaining 20% from this subsample, the algorithm applies logic to determine if the reported data 22 is anomalous but should be retained for future computation as the algorithm builds a larger corpus of historical data that would toggle the data from being anomalous to statistically relevant.

2. In addition to the calculations provided by algorithm 100 for the above results, the calculations would apply a weight in the calculation of any given average offset. For example, the weight applied to one (or more) reporting devices 20 may be increased or decreased as a result of other associated data provided by that device. This weight could be calculated by a number of factors including, but not limited to:
a. Frequency in which offset data 22 is provided by the device 20 relative to other devices 20
b. Deviation of offset data 22 provided by the device 20 between individual historical reporting intervals
c. Deviation of offset data 22 provided by the device 20 relative to all other reporting devices with similar characteristics (type, frequency, location, deviation)
d. Behavioral and usage patterns of the individual device 20 of user 10.
e. Any other method deemed statistically relevant by the algorithm and its training methods

It should be noted that all calculations made by algorithm 100 are determined dynamically based on identified patterns of statistically relevant data. The accuracy of the calculations and correction data 122 improves as the size and consistency of the sample set increases.

As previously discussed, algorithm 100 calculates average sensor offsets centrally, and then these average offsets are published to the target devices 20 within system 1 over a networked connection. The publication interval is configurable and can be event driven. It can also be invoked either by the service (i.e. algorithm 100 itself), device 20, or both. If for example, algorithm 100 determines that for all iPhone® 4s devices that are within the Chicago metro area have an average offset (weighted) of +7 degrees for their embedded magnetometers, then this offset would be made available to all those target devices via the central algorithm 100 that is cloud or service based. Once this offset data 122 is received by the target device(s) 20, an application or other method relying on this offset data 122 would have the ability to apply the standard offset as provided by the service, or calculate some other offset that uses the service-provided offset 122 in conjunction with other device or sensor data already contained within the unique device 20 natively, or through prior offset calculation made programmatically or by the user as described earlier.

This can be done on a launch of an application using algorithm 100, at a prescribed frequency, based on a user action or by other programmatic means. Algorithm 100 has the ability to “package” all offset data (not just for the magnetometer, but for all sensor offset data contained in system 1) in a single network transaction. This is intended to reduce the number of network round trips as well as to preserve battery life and network throughput for the connected devices 20.

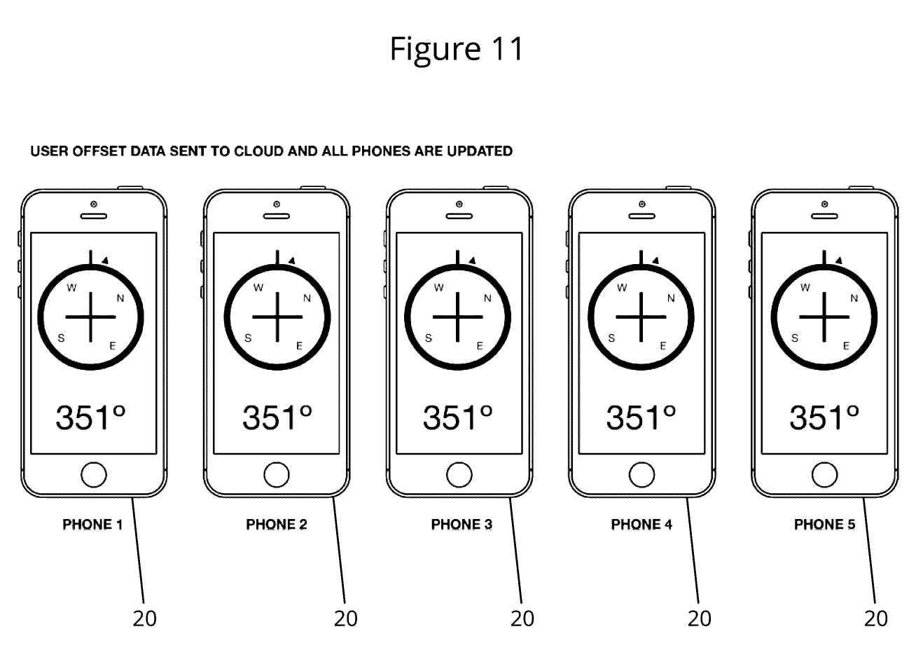

FIG. 11 shows a plurality of devices 20 after they have received corrected data 122. As is shown, after algorithm 100 receives data 22 from one or more of devices 20, it calculates appropriate correction data 122 according to the various methods described above. This corrected data 122 is transmitted back to each of devices 22, so that the sensors in each device 20 have correct information.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A system for correcting sensor data of a user device, comprising:
a device comprising a sensor;
a computing cloud, wherein said user device is in communication with said computing cloud; and
an algorithm resident on said user device, said computing cloud, or both of said user device and said computing cloud,
wherein said algorithm acquires sensor data from said sensor, transmits a data set back to said user device, calculates an offset error in said sensor data based on said data set, and transmits corrected offset data back to said user device.

2. The system of claim 1, wherein said sensor data is implicit, explicit, or a combination of the two.

3. The system of claim 2, wherein said algorithm calculates said offset error based on said implicit data, said explicit data, or a combination of the two.

3. The system of claim 1, wherein a first portion of said algorithm is resident on said device, and a second portion of said algorithm is resident on said computing cloud.

4. The system of claim 1, wherein said device is a plurality of devices, each of which is in communication with said computing cloud.

5. The system of claim 4, wherein said algorithm transmits said corrected data back to at least one of said plurality of devices.

6. The system of claim 1, wherein said sensor data comprises a parameter selected from the group consisting of the location of said device, a heading of said device, a track of said device, the type of said device, the operating system of said device, the perspective of said device perspective, an image acquired by said device, information relating to a user of said device, an operating system of said device, category, user preferences relating to said device, and any combinations thereof.

7. The system of claim 1, wherein said algorithm allows a user to manually manipulate said data set, and calculates said corrected offset data based on said manual manipulation.

8. The system of claim 7, wherein said algorithm allows the user to adjust a size of said data set via said manual manipulation.

9. The system of claim 7, wherein said algorithm allows the user to adjust a location of said data set via said manual manipulation.

10. The system of claim 1, wherein said sensor of said device is a compass, and said algorithm allows a user to manually manipulate a heading of said compass.

11. The system of claim 1, wherein said sensor is a camera, and said data set is an overlay image, so that said algorithm applies said overlay image onto an image acquired by said camera.

12. The system of claim 1, wherein said algorithm allows a user to manually apply corrections to outputs of said sensor.

13. The system of claim 1, wherein said algorithm can triangulate the location of a source of interference based on said sensor data.

14. The system of claim 1, further comprising a software agent that acts on behalf of a user or other device to generate the most contextually aware query to retrieve a result or experience.
